(19) United States
(12) Patent Application Publication
(10) Pub. No.: US 2013/0316166 A1
(43) Pub. Date: Nov. 28, 2013

(54) Material with Variable Optical Transmission Based on a Porous Matrix that Includes Hygroscopic or Deliquescent Substances and Device that Comprises Said Material

(71) Applicants: David S. Levy Cohen, Madrid (ES); Marcos D. Zayat Souss, Madrid (ES); Erick Castellon Elizondo, Madrid (ES)

(72) Inventors: David S. Levy Cohen, Madrid (ES); Marcos D. Zayat Souss, Madrid (ES); Erick Castellon Elizondo, Madrid (ES)

(73) Assignee: Consejo Superior De Investigaciones Cientificas (CSIC), Madrid (ES)

(21) Appl. No.: 13/884,722

(22) PCT Filed: Nov. 8, 2011
(86) PCT No.: PCT/EP2011/069677

§ 371 Date: Jul. 3, 2013

(30) Foreign Application Priority Data
Nov. 10, 2010 (ES) 201031656

(51) Int. Cl. G02B 1/10

(52) U.S. Cl. CPC G02B 1/10
USPC 428/319.1; 428/304.4; 428/319.3; 106/287.35; 521/149; 501/32; 106/287.1; 106/287.27; 106/18.11; 106/15.05; 106/122

(57) ABSTRACT

The present invention provides a material that comprises hygroscopic or deliquescent particles encapsulated in a transparent matrix which may or may not be on a support or substrate, the process for obtaining said material and the use thereof for the manufacturing of devices with controlled variable optical transmission.

The present invention relates to a material capable of varying its optical properties and the process for the obtainment thereof, in addition to the use thereof as a device with controllable variable optical transmission.

### PRIOR STATE OF THE ART

In recent years, numerous systems, based on different principles, have been developed for application in smart windows, to obtain a variable transmission window, which, in many cases, use techniques that are very complicated and costly to manufacture, particularly for large façade dimensions. Some of these techniques are based on liquid crystal (LC), which is a substance that exhibits a quasi-crystalline molecular order in the liquid state of matter; these extraordinary characteristics confer special optical, electrical and rheological properties to the materials, which are utilised in many devices, such as screens and optical windows (J. W. Doane, Lig. Cryst. 33 (2006) 1313). Some examples include: the line of Smart Glasses, under the name Vitro, from Dream Glass S. L., which may be activated simply by pressing a switch, thereby facilitating the desired privacy, manufactured with PDLC (Polymer Dispersed Liquid Crystal) (US4688900, US4435047, US4994204); the screens from Elmont Glass Company Inc. (Garden City Park, N.Y.) and those from Paragon Architectural Products LLC (Scottsdale, Ariz.), based on the same technology for screens, which change their transmission between opaque and transparent within seconds by means of a switch; the windows from Research Frontiers Inc., that change from opaque to transparent and the technology whereof is based on the dispersion of suspended particles (SPD) (U.S. Pat. No. 5,463,491 and U.S. Pat. No. 6,301,040), which change their refractive index upon applying an electric current, since said particles are ordered, thereby increasing the transmittance; Priva-Lite from Saint-Gobain is another example of privacy windows from this manufacturer, based on the same PDLC technology; another example from the manufacturer Scienstry, Inc. is based on NPD-LCD (Non-homogeneous PDLC), very similar to the preceding one. Similar inventions are GDLC glasses (Gel-glass Dispersed Liquid Crystal), electro-optic devices for variable transmission systems and windows that are based on the microencapsulation and dispersion of liquid crystal (LC) in glass coatings or layers by means of the Sol-Gel process, which have been disclosed in patent ES2137065. As in the case of PDLCs, GDLC electro-optic devices strongly disperse light at rest (OFF), and become more transparent when an external electric field is applied thereto (ON state) (D. Levy, C. J. Serna and J. M. Otón, Mater. Letters, 10 (9.10), 1991: 470-476); (J. M. Otón, A. Serrano, C. J. Serna and D. Levy, Liquid Crystals, 10 (5), 1991: 733-739); (M. Zayat and D. Levy, Chemistry of Materials (2003) 15 (11), 2122-2128); (M. Zayat and D. Levy, Journal of Materials Chemistry (2005) 15 (35-36), 3769-3775).

### DESCRIPTION OF THE INVENTION

The present invention provides a material that comprises hygroscopic and/or deliquescent substances encapsulated in a transparent porous matrix which may or may not be deposited on a support or substrate, to the process for obtaining said material, and the present invention further discloses the use thereof for the manufacturing of devices with controlled variable optical transmission or reflection.

A first aspect of the present invention relates to a material (hereinafter material of the invention) that comprises at least one transparent porous matrix and hygroscopic and/or deliquescent substances. Said substances are contained inside the transparent matrix.

In a preferred embodiment, the material of the invention further comprises a support or substrate. In a more preferred embodiment, the support is a glass, a polymer or a metal. In another, more preferred embodiment, the support is transparent or reflectant.

In the present invention, “support” is understood to mean an inert substance which, in a given process, provides the adequate contact surface or fixes any of the reagents thereof.

In the present invention, “substrate” is understood to mean a stratum that underlies another and which may have an influence thereon.

The transparent porous matrix may have a mean pore size of between 50 nm and 50 μm.

In a preferred embodiment, the transparent porous matrix is selected from organic, inorganic, hybrid organic-inorganic or any combination thereof.

In a more preferred embodiment, the organic transparent matrix is a polymer. And, in an even more preferred embodiment, the polymer is selected from poly(methoxyethylacrylamide) (PMEA), poly(hydroxyethyl methacrylate) (PHEMA), methyl polymethacrylate (PMMA), polystyrene (PS), poly(butylacrylate) (PBuA), poly(ethylene terephthalate) (PET), poly(ethyl methacrylate), poly(vinyl butyral), poly(methyl acrylate), poly(vinyl formal), poly(vinyl alcohol) (PVA), cellulose nitrate, gelatine, silicones, Carbopol®, Gantrez® or any combination thereof. Due to the possible combinations between the polymers, they may form copolymers or polymer mixtures.

In another, more preferred embodiment, the inorganic transparent matrix is a glass. In an even more preferred embodiment, the glass comprises oxides selected from silicon oxide, titanium oxide, zirconium oxide, aluminum oxide, germanium oxide, tin oxide, lead oxide, boron oxide, sodium oxide, potassium oxide, calcium oxide, magnesium oxide, barium oxide, tungsten oxide, or any combination thereof.

In another, more preferred embodiment, the organic-inorganic hybrid transparent matrix is organically-modified silica. And, in an even more preferred embodiment, the organically-modified silica is selected from alkyl silica, aryl silica or any combination thereof.

In the present invention, the term “alkyl” refers to hydrocarbonated chain radicals, linear or branched, that have between 1 and 20 carbon atoms, preferably between 1 and 10, which bind to the rest of the molecule by means of a single bond, for example, methyl, ethyl, n-propyl, i-propyl, n-butyl, tert-butyl, sec-butyl, n-pentyl, n-hexyl, etc. Optionally, the alkyl groups may be substituted with one or more substituents, such as halogen, hydroxyl, alkoxyl, carboxyl, carbonyl, cyano, acyl, alkoxycarbonyl, amino, nitro, mercapto and alkylthio.

In the present invention, the term “aryl” refers to a phenyl, naphthyl, indenyl, phenanthryl or antracyl radical, preferably phenyl. Optionally, the aryl radical may be substituted with one or more substituents, such as alkyl, haloalkyl, aminoalkyl, dialkylamino, hydroxyl, alkoxyl, phenyl, mercapto, halogen, nitro, cyano and alkoxycarbonyl.

Preferably, the hygroscopic and/or deliquescent substances are selected from CaCl₂, MgCl₂, ZnCl₂, K₂CO₃, K₃PO₄, KOH, NaOH or any combination thereof. More preferably, the hygroscopic and/or deliquescent compound is CaCl₂.

In a preferred embodiment, the hygroscopic and/or deliquescent substances are in the form of particles with a size of between 50 nm and 200 nm.

The hygroscopic and/or deliquescent substances are encapsulated in the porous matrix, and may be both in the solid state (forming particles) and the liquid state, dissolved as a function of the degree of humidity (see FIG. 1).

The material of the invention may be rigid or flexible, and the resulting matrix is not deteriorated upon curving or twisting it. This property will be dependent on the matrix and/or the support used. This property makes it possible to improve its mechanical properties against blows, twisting, and, therefore, its applicability in non-static substrates or curved surfaces that require flexibility, changes in appearance or shape.

Preferably, the material of the invention further comprises an additive, which may be any additive used in the field of polymers or glasses known to any person skilled in the art. More preferably, the additive is selected from colouring agents, plasticisers, stabilisers, flame retardants, adhesion-improving agents, antioxidants, anti-static agents, curing agents, UV absorbers, IR reflectants, biocides, lubricants, optical brighteners, emulsifiers, surfactants or any combination thereof.

In a preferred embodiment, the weight ratio between the transparent matrix and the hygroscopic and/or deliquescent substances is between 100:1 and 1:10.

The material of the invention may be characterised in that the matrix and the pores wherein the hygroscopic and/or deliquescent substances are contained have a different refractive index. In turn, the material of the invention may be characterised in that the refractive index between the pores and the hygroscopic and/or deliquescent substances varies as a function of humidity.

A second aspect of the present invention relates to the use of the material of the invention, for the manufacturing of a device.

Preferably, the device is an optical device.

In a preferred embodiment, the device is adapted to modulate the transparency by means of a method that is selected from control of the humidity, temperature, pressure, exposure to vapours of substances that reversibly dissolve the hygroscopic and/or deliquescent substances, or any combination thereof. The substances with a capacity to reversibly dissolve the hygroscopic and/or deliquescent substances may be alcohols, such as, for example, without being limited thereto, ethanol.

In a more preferred embodiment, modulation of the transparency of the device is performed by controlling the humidity through the application of dry air or humid air.

The humidity is controlled by exposing the device to a humid gas environment, where the hygroscopic and/or deliquescent substances, encapsulated in the matrix pores, absorb water and become dissolved, thereby filling the pores in whole or in part. Thus, the refractive index between the solution of hygroscopic substances and the transparent encapsulation matrix is levelled off, and, as a result, the device achieves a transparent state. On the other hand, when the device is exposed to a dry gas environment, the humid or dissolved hygroscopic and/or deliquescent substances lose water and allow for the entrance of air into the pores, which causes a change in the refractive index of the pores wherein said substances are encapsulated, making it different from that of the transparent encapsulation matrix. As a consequence, the device achieves a translucent state, and it may reach a quasi-opaque state depending on the matrix thickness, the nature of the pores thereof and the concentration of hygroscopic and/or deliquescent substances in the matrix (see FIG. 2).

A third aspect of the present invention relates to a process for obtaining the material of the invention, characterised in that it comprises the following steps:
a) mixing of the transparent porous matrix formers with the hygroscopic and/or deliquescent substances or precursors thereof, in a liquid medium, and
b) heat treatment of the coating obtained in (a) at a temperature of between 0° C. and 200° C.

The hygroscopic and/or deliquescent substances may be added to the solution of matrix formers as such, or the precursors thereof may be added; these may be in the form of salts dissolved in the solution in such a way that they precipitate to form solid substances, such as particles, during the heat treatment of step (b), remaining encapsulated in the matrix pores.

The process of the invention may further comprise, in step (a), the addition of the additive to the mixture.

In a preferred embodiment, the transparent matrix formers are selected from organic, inorganic or any combination thereof.

In a more preferred embodiment, the inorganic matrix former is selected from silicon, titanium, aluminum, zirconium, germanium, tin, lead, boron, sodium, potassium, calcium, magnesium, barium, or tungsten alkoxides, oxides or salts, or any combination thereof.

In a more preferred embodiment, the organic matrix formers comprise monomers or polymers selected from methyl methacrylate, methoxyethylacrylamide, hydroxyethyl methacrylate, ethyl methacrylate, styrene, butylacrylate, ethylene terephthalate, polyvinyl butyral, polyvinyl formal, poly(vinyl alcohol), cellulose, cellulose nitrate, gelatine, Carbopol®, Gantrez® or any combination thereof.

Preferably, the liquid medium of step (a) is an aqueous medium, an organic solvent or any combination thereof. And, more preferably, the organic solvent is a C₁-C₁₀ alcohol.

The process of the invention may further comprise a step subsequent to the support-coating step (a).

In a more preferred embodiment, the coating is performed by means of a process selected from bar-coating, spin-coating, dip-coating, spraying, silkscreen printing, ink-jet printing or any combination thereof.

Preferably, the heat treatment of step (b) is performed by introduction into an oven or exposure to a heat source.

Subsequent to step (b), the material, whether polymeric or vitreous, may be subjected to any material processing method known to any person skilled in the art, such as, for example, without being limited thereto, cutting, polishing, pressing, engraving, drilling, curving, laminating, rough grinding, frosting, beveling, tempering, perforation, dyeing, brightening or any combination thereof.

A fourth aspect of the present invention relates to a device that comprises at least one material of the invention.

In a preferred embodiment, the device comprises two materials with a support placed face-to-face, with an air chamber between them.

In another preferred embodiment, the device comprises at least one material with a support facing an identical or different support, with an air chamber between them.

Another aspect of the present invention relates to the use of the device as disclosed above, for the manufacturing of objects selected from light regulators, shop windows, façades, automobile roofs, windows, ceiling panels, skylights, mirrors, for applications in architecture, interior decoration, building exteriors, doors, windows, separation partitions between areas in offices or homes, elements for the regulation of or protection against light, information visualisation screens, window labelling, smart buildings or as humidity sensors.

In the event that the device of the present invention is manufactured in the form of a panel or windows, it may protect against solar radiation; moreover, it may be used in both interiors and exterior façades. As a result, the window may be capable of controlling the sunlight that passes therethrough, in some cases being adequate to ultimately reduce the air conditioning load of a building in summer and the heating load in winter; therefore, the device of the invention offers an optimisation of energy resources in buildings.

Another significant advantage of the device of the present invention is that the response times in both directions, translucent or opaque to transparent and transparent to translucent or opaque, are of the order of seconds, which makes it valid to be applied in a large number of applications.

On the other hand, the main advantage of the process for obtaining the devices of the invention is that large, industrial-scale production may be performed, by means of a simple assembly.

Throughout the description and the claims, the word “comprises” and the variants thereof are not intended to exclude other technical characteristics, additives, components or steps. For persons skilled in the art, other objects, advantages and characteristics of the invention will arise partly from the description and partly from the practise of the invention. The following examples and drawings are provided for illustrative purposes, and are not intended to limit the scope of this invention.

### BRIEF DESCRIPTION OF THE FIGURES

FIG. 1.—Operating diagram of the material of the invention in the event that there is exposure to water vapours, the hygroscopic and/or deliquescent substances being reversibly dissolved.

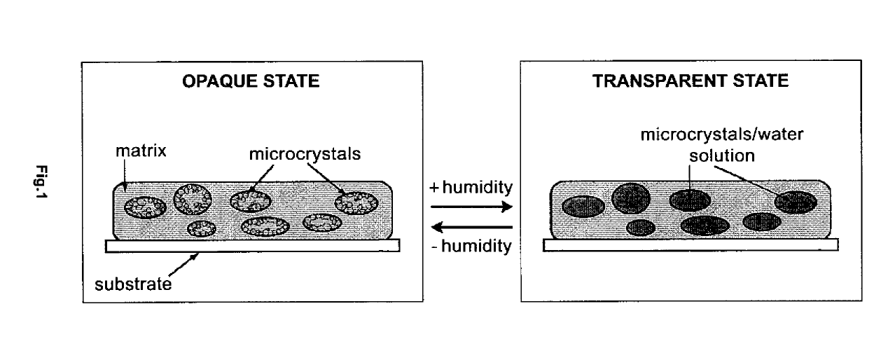

FIG. 2.—Operating diagram of the device of the invention.

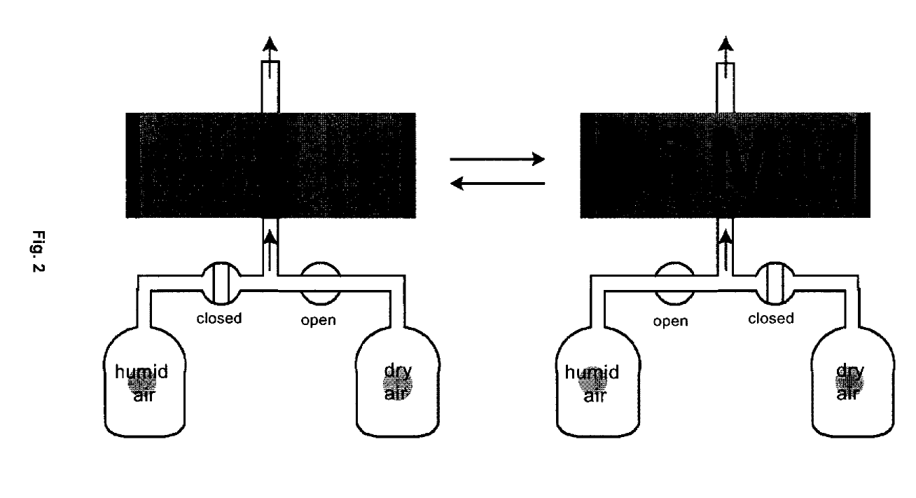

### EXAMPLES

Below we will illustrate the invention by means of assays performed by the inventors, which show the specificity and effectiveness of the material and the device of the invention.

### Example 1

### Coating Composed of CaCl₂ Particles Dispersed in an Organic-Inorganic Hybrid Porous Matrix, Deposited on a Glass Substrate

4.5 mmol of ethyl triethoxysilane, 9.0 mmol of tetraethoxysilane, 4.5 mmol of titanium tetraisopropoxide and 63.0 mmol of ethyl alcohol are mixed, at ambient temperature and under stirring. Subsequently, 9.0 mmol of ethyl acetylacetonate are added to this mixture. This mixture is allowed to react for 5 minutes and, subsequently, 36.0 mmol of water and 2.5 mmol, 0.19 ml of HNO₃ (13.1 mol I⁻¹) are added. The mixture obtained is allowed to react for 24 hours at 50° C. 4.9 mmol of CaCl₂.2H₂O and 2.0 ml of a solution of hydroxypropyl cellulose (HPC) in ethanol (0.50 g of HPC+10.0 ml of ethanol) are added to this mixture and it is homogenised under stirring.

The mixture obtained is used to form the films on glass substrates, by means of the bar coating technique, with a bar that produces a 10-μm-thick liquid film at a velocity of 250 mm s⁻¹; subsequently, the film is dried at 100° C. for 24 hours.

The devices are assembled by placing two of these coated substrates face to face on the side of the coatings; spacers are used to fix the space between the coatings.

### Example 2

### Coating Composed of CaCl₂ Particles Dispersed in a Porous Polymeric Matrix (MMA-HEMA Copolymer), Deposited on a Glass Substrate

100 mg of the copolymer poly(methyl methacrylate-co-hydroxyethyl methacrylate), with a molar proportion MMA/HEMA=1, are dissolved in 30.96 mmol of 2-hydroxyethyl-ethanol. 0.60 ml of a solution of CaCl₂.2H₂O in ethanol (concentration of 2.45 mol/l) are added to this solution; it is stirred until complete dissolving is achieved. The mixture obtained is used to form the films on glass substrates, by means of the spin coating technique, at a velocity of 2000 rpm. Subsequently, this film is dried at 100° C. for 24 hours.

The devices are assembled by placing two of these coated substrates face to face on the side of the coatings; spacers are used to fix the space between the coatings.

### Example 3

### Coating composed of CaCl₂ articles dispersed in an inorganic porous matrix Deposited on a Glass Substrate

13.5 mmol of tetraethoxysilane, 4.5 mmol of titanium tetraisopropoxide and 100 mmol of ethyl alcohol are mixed, at ambient temperature (20° C.-25° C.) and under stirring. Subsequently, 9.0 mmol of ethyl acetylacetonate are added to this mixture. This mixture is allowed to react for 5 minutes and, subsequently, 36.0 mmol of water and 0.19 ml of HNO₃ (13.1 mol·I⁻¹) are added. The mixture obtained is allowed to react for 24 hours at 50° C. 4.9 mmol of CaCl₂.2H₂O are added to this mixture and it is homogenised under stirring.

The mixture obtained is used to form the films on glass substrates, by means of the bar coating technique, with a bar that produces a 10-μm-thick liquid film at a velocity of 250 mm s⁻¹; subsequently, the film is dried at 100° C. for 24 hours.

The devices are assembled by placing two of these coated substrates face to face on the side of the coatings; spacers are used to fix the space between the coatings.

1. A material that comprises at least one transparent porous matrix and hygroscopic and/or deliquescent substances.

2. The material according to claim 1, which further comprises a support or substrate.

3. The material according to claim 2, where the support is a glass, a polymer or a metal.

4. The material according to claim 3, where the support is transparent or reflectant.

5. The material according to claim 1, where the transparent porous matrix has a mean pore size of between 50 nm and 50 μm.

6. The material according to claim 1, where the transparent porous matrix is selected from organic, inorganic, hybrid organic-inorganic or any combination thereof.

7. The material according to claim 6, where the organic transparent porous matrix is a polymer.

8. The material according to claim 7, where the polymer is selected from poly(methoxyethyl acrylamide) (PMEA), poly(hydroxyethyl methacrylate) (PHEMA), poly(methyl methacrylate) (PMMA), polystyrene (PS), poly(butyl acrylate) (PBuA), poly(ethylene terephthalate) (PET), poly(ethyl methacrylate), poly(vinyl butyral), poly(methyl acrylate), poly(vinyl formal), poly(vinyl alcohol) (PVA), cellulose nitrate, gelatine or any combination thereof.

9. The material according to claim 6, where the inorganic transparent porous matrix is a glass.

10. The material according to claim 9, where the glass comprises oxides selected from silicon oxide, titanium oxide, zirconium oxide, aluminum oxide, germanium oxide, tin oxide, lead oxide, boron oxide, sodium oxide, potassium oxide, calcium oxide, magnesium oxide, barium oxide, tungsten oxide or any combination thereof.

11. The material according to claim 6, where the organic-inorganic hybrid transparent porous matrix is organically-modified silica.

12. The material according to claim 11, where the organically-modified silica is selected from alkyl silica, aryl silica or any combination thereof.

13. The material according to claim 1, where the hygroscopic and/or deliquescent substances are selected from CaCl₂, MgCl₂, ZnCl₂, K₂CO₃, K₃PO₄, KOH, NaOH or any combination thereof.

14. The material according to claim 13, where the hygroscopic and/or deliquescent particles are of CaCl₂.

15. The material according to claim 14, where the hygroscopic and/or deliquescent substances are forming particles with a size of between 50 nm and 200 nm.

16. The material according to claim 1, which further comprises an additive selected from colouring agents, plasticisers, stabilisers, flame retardants, adhesion-improving agents, antioxidants, anti-static agents, curing agents, UV absorbers, IR reflectants, biocides, lubricants, optical brighteners, emulsifiers, surfactants or any combination thereof.

17. (canceled)

18. The material according to claim 1, where the weight ratio between the transparent porous matrix and the hygroscopic and/or deliquescent substances is between 100:1 and 1:10.

19. The material according to claim 1, characterised in that the matrix and the pores containing the hygroscopic and/or deliquescent substances have a different refractive index.

20-23. (canceled)

24. Method for obtaining the material according to claim 1, characterised in that it comprises the following steps:
a. mixing of the transparent porous matrix formers with the hygroscopic and/or deliquescent substances, or the precursors thereof, in a liquid medium, and
b. heat treatment of the coating obtained in (a) at a temperature of between 0° C. and 200° C.

25-33. (canceled)

34. Device that comprises at least one material according to claim 1.

35-37. (canceled)
